(19) United States
(12) Patent Application Publication
(10) Pub. No.: US 2002/0124064 A1
(43) Pub. Date: Sep. 5, 2002

(54) Method and apparatus for managing a network

(76) Inventors: Mark E. Epstein, San Francisco, CA (US); Roland C. Dowdeswell, New York, NY (US); Michael F. Cuddy, Redwood City, CA (US); C. Erik Berls, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/005,396

(22) Filed: Dec. 4, 2001

Related U.S. Application Data
(60) Provisional application No. 60/261,487, filed on Jan. 12, 2001.

(51) Int. Cl. G06F 15/177

(52) U.S. Cl. 709/221; 717/171

(57) ABSTRACT

A method and apparatus to manage a plurality of devices is described. The apparatus comprises a control server to generate a job to update a device, and a control point to establish a secure communication with the control server, and to receive the job. The control point further to establish communication with the device in accordance with a maintenance schedule, and to update the device using the JobScript found within the job.

### FIELD OF THE INVENTION

The present invention relates to network control, and more specifically, to controlling a network through distributed control points.

### BACKGROUND

There are many ways of controlling a network. However, most of these ways do not cope gracefully with an expanding network, do not successfully distribute work, and/or do not maintain security during the control process.

For example, one prior art method of controlling a network is to physically install new systems using a trusted installer. The installer would have a key or other security mechanism that would be added to the new system on the network. The network then would accept the new system, and would treat it as a trusted connection. If the system on the network needed to be upgraded, a human would have to go out to the system, and upgrade it manually. While this system functions, it becomes difficult if not impossible to maintain when the number of systems coupled the network grows. Furthermore, if the network is a distributed system—with computers and other devices at locations all over the world—each location would have to have an actual human able to upgrade the local system. Additionally, it becomes almost impossible to upgrade all systems at the same time, without taking down the network. Furthermore, security may be compromised at any of the multiple locations, and this would not be known until a human verified the security of the system. Therefore, an automated network maintenance and control system would be advantageous.

### SUMMARY OF THE INVENTION

A method and apparatus to manage a plurality of devices is described. The apparatus comprises a control server to generate a job to update a device, and a control point to establish a secure communication with the control server, and to receive the job. The control point further to establish communication with the device in accordance with a maintenance schedule, and to update the device using the JobScript found within the job.

### DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of one embodiment of a network with control servers, control points, and devices.

FIG. 2 is a block diagram of one embodiment of a computer system that may be used with the present invention.

FIG. 3 is a block diagram of one embodiment of a control server.

FIG. 4 is a block diagram of one embodiment of a control point.

FIG. 5 illustrates one embodiment of the hierarchical structure of the data store.

FIG. 6A is a flowchart of one embodiment of installing a control point, from the control server's perspective.

FIG. 6B is a flowchart of one embodiment of installing a control point, from the control point's perspective.

FIG. 7A is a flowchart of one embodiment communication between the control server and the control point, from the control server's perspective.

FIG. 7B is a flowchart of one embodiment of communication between the control server and the control point, from the control point's perspective.

FIG. 7C illustrates one embodiment of establishing connection to the control server, including control server failover, from the perspective of the control point.

FIG. 8 is a flowchart of one embodiment of updating a device from a control point.

FIG. 9 illustrates one embodiment of command flow-through from the data store to a device.

FIG. 10 illustrates one embodiment of generating the data sent by the control server to the control point.

FIG. 11 illustrates one embodiment of a device module.

FIG. 12 illustrates one embodiment of the history/versioning process.

### DETAILED DESCRIPTION

A method and apparatus for network control is described. The system deploys remote control points, which control the various devices that are part of the network. This system may be used, for example, to rapidly provision network elements, audit configurations of network elements, provide fine-grained security access control across the network fabric, and rapidly configure and maintain Virtual Private Network, firewall, and router configurations on the network. The system may also be used within a corporate environment to control all of the devices that are on the network.

The system permits access to the data store using a Command Line Interface (CLI) and a graphical user interface (GUI). The underlying database, for one embodiment, is a SQL database. For one embodiment, the data store includes a schema translator that presents the underlying SQL database as a hierarchical data store.

Using the CLI, GUI, or service modules, the user may make changes in the data store. Service modules permit functionality to be defined and “plugged in” into the control server. Service modules may be designed by users, and may interface with the control server to provide additional usability or alternative interface mechanisms. The user may also create action scripts which use the CLI. Action scripts may have additional linked scripts or commands, such that a second script is started after one or more commands from the first script have been completed. For one embodiment, the system may include a default action script, such that upon the execution of any command or a defined set of commands, the default action script is triggered, unless an alternative action script is identified by the user.

In order to make changes to the devices coupled to the network, the user simply changes data in the data store. Such a change in the data store triggers an automatic job generation, to generate an appropriate job to update the device(s) affected by the change in the data store. The control server then contacts the control point that controls the device(s) affected by the change, using a doorbell mechanism. This triggers the set-up of a secure communications method between the control server and the control point. The data sent by the control server to the control point is a job, which includes a JobScript that delivers any appropriate changes to the device configuration. The term delivery driver may be used for JobScript. The job may further include references to files that are needed. This user-modifiable job is executed within the control point.

For one embodiment, the control point caches any support files that have been previously used, such that only a single copy of any support file needs to be transferred to the control point, even if multiple devices are being reconfigured.

The control point then contacts the device, at the preset maintenance window of that device. The control point has its own scheduler, which is used to schedule the jobs sent to it by the control server.

The device is then successfully updated, and data regarding the update, including a transcript of the update process, is sent back to the control server. The data store also stores the previous state of each device, providing historical states and versioning for every device. This permits a user to, for example, review previous states, or revert to a previous state. The previous states of each device are saved in the device profile for that device as well as in the device configuration file. In this way, a user may review the exact of a particular device at any past point—using the device configuration file—as well as configure an alternative device to the exact same configuration, using the device profile.

Users have full control of configuration via device profiles, templates, and other means. One of the other means present is “service modules.” Service modules permit functionality to be defined and “plugged in” into the control server. Users and service modules can insert information into the data store to control the various devices on the network. Users and service modules can define “new types” of data, i.e. arbitrary attributes in the data store. The service modules may define any types of actions or functions that may alternatively be individually executed by a user.

Generating new control points is also simple. The control server generates a localized version of the control point, which is then installed on a machine. Localization creates a control point that knows which control server it belongs to. IP localization takes place when a passphrase is entered into the control point, as will be discussed below. For another embodiment, a dedicated appliance may be used. A passphrase is then generated. For one embodiment, the passphrase is a set of English words, of a specific length, such as four letters. This permits easy entry by user, and reduces the likelihood of mistyping. The passphrase includes, encoded within it, a one-time key or nonce, which then used by the newly set up control point to check in with the control server. The control server and control point then finish a key exchange process, and in future communication use a public key based communication.

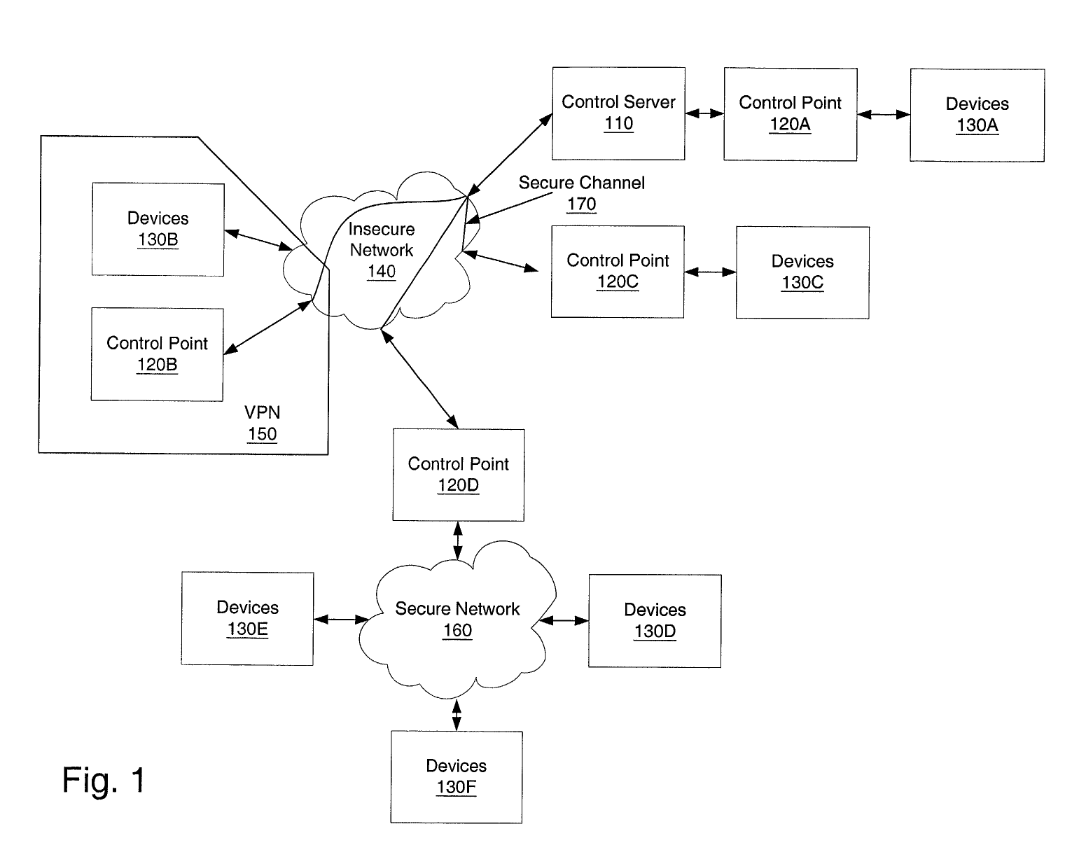

FIG. 1 is a block diagram of one embodiment of a network with control servers, control points, and devices. The control server 110 provides network control functions, and interacts with the control points 120 (A-D). The control server 110 provides a user interface, which allows the administrator to set up and manage control points 120, and manage the devices 130 (A-D) on the network through control points 120.

The control server 110 may be coupled to the control point 120 through an insecure network 140. However, a secure communication channel 170 is established between the control server 110 and the control point 120. The secure communication channel may be secure sockets layer (SSL), secure shell (SSH), or any other secure communication protocols or mechanisms. One embodiment of establishing this secure communication method is described below. Alternatively, control server 110 may be coupled to control point 120 through a direct, secure connection.

Control points 120 are coupled to at least one device 130. Control points 120 may be coupled to a device through a direct connection, through a secure network 160, through an insecure network, or through a Virtual Private Network 150. Note that multiple control points 120 may control the same device. The control server 110 ensures that only one control point 120 talks to any device 130 at the same time. The control point 120 need not know which devices it is coupled to until it receives a job for that device.

As will be described below in more detail, the control points 120 permit a distributed management of the entire network 100. Furthermore, since the communication between the control point 120 and control server 110 is secure, overall security is enhanced.

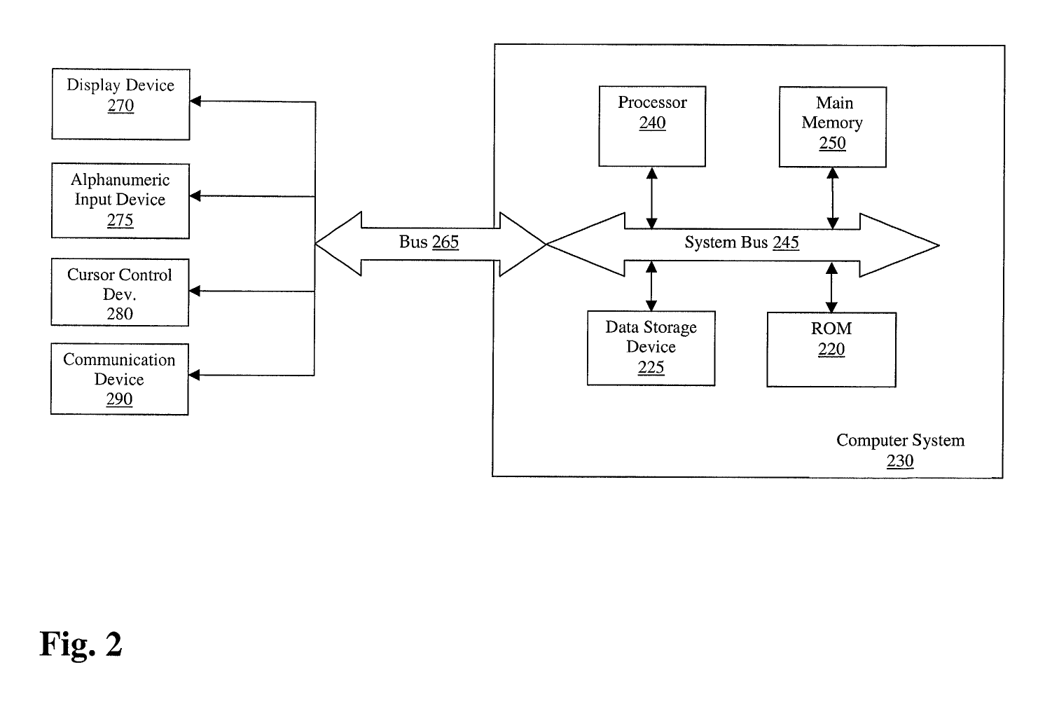

FIG. 2 is one embodiment of computer system on which the present invention may be implemented. FIG. 2 illustrates a typical data processing system upon which one embodiment of the present invention is implemented. It will be apparent to those of ordinary skill in the art, however that other alternative systems of various system architectures may also be used.

The data processing system illustrated in FIG. 2 includes a bus or other internal communication means 245 for communicating information, and a processor 240 coupled to the bus 245 for processing information. The system further comprises a random access memory (RAM) or other volatile storage device 250 (referred to as memory), coupled to bus 245 for storing information and instructions to be executed by processor 240. Main memory 250 also may be used for storing temporary variables or other intermediate information during execution of instructions by processor 240. The system also comprises a read only memory (ROM) and/or static storage device 220 coupled to bus 240 for storing static information and instructions for processor 240, and a data storage device 225 such as a magnetic disk or optical disk and its corresponding disk drive. Data storage device 225 is coupled to bus 245 for storing information and instructions.

The system may further be coupled to a display device 270, such as a cathode ray tube (CRT) or a liquid crystal display (LCD) coupled to bus 245 through bus 265 for displaying information to a computer user. An alphanumeric input device 275, including alphanumeric and other keys, may also be coupled to bus 245 through bus 265 for communicating information and command selections to processor 240. An additional user input device is cursor control device 280, such as a mouse, a trackball, stylus, or cursor direction keys coupled to bus 245 through bus 265 for communicating direction information and command selections to processor 240, and for controlling cursor movement on display device 270.

Another device that may optionally be coupled to computer system 230 is a communication device 290 for accessing other nodes of a distributed system via a network. The communication device 290 may include any of a number of commercially available networking peripheral devices such as those used for coupling to an Ethernet, token ring, Internet, or wide area network. Note that any or all of the components of this system illustrated in FIG. 2 and associated hardware may be used in various embodiments of the present invention.

It will be appreciated by those of ordinary skill in the art that any configuration of the system may be used for various purposes according to the particular implementation. The control logic or software implementing the present invention can be stored in main memory 250, mass storage device 225, or other storage medium locally or remotely accessible to processor 240. Other storage media may include floppy disks, memory cards, flash memory, or CD-ROM drives.

It will be apparent to those of ordinary skill in the art that the methods and processes described herein can be implemented as software stored in main memory 250 or read only memory 220 and executed by processor 240. This control logic or software may also be resident on an article of manufacture comprising a computer readable medium having computer readable program code embodied therein and being readable by the mass storage device 225 and for causing the processor 240 to operate in accordance with the methods and teachings herein.

The software of the present invention may also be embodied in a dedicated appliance containing a subset of the computer hardware components described above. For example, the dedicated appliance may be configured to contain only the bus 245, the processor 240, and memory 250 and/or 225. The handheld device may also be configured to include a set of buttons or input signaling components with which a user may select from a set of available options. The dedicated appliance may also be configured to include an output apparatus such as a liquid crystal display (LCD) or display element matrix for displaying information to a user of the dedicated appliance. Conventional methods may be used to implement such a dedicated appliance. The implementation of the present invention for such a device would be apparent to one of ordinary skill in the art given the disclosure of the present invention as provided herein.

For one embodiment, control points 120 may be installed as an application on a standard personal computer. For one embodiment, the personal computer may become a dedicated system, which is only used as a control point 120. For one embodiment, the control point 120 runs over a hardened NetBSD operating system. The system may retain the ability to dual boot, into another operating system, such as Windows. For another embodiment, the device may be a dual use system, in which the control point 120 runs in the background, while the computer remains useable.

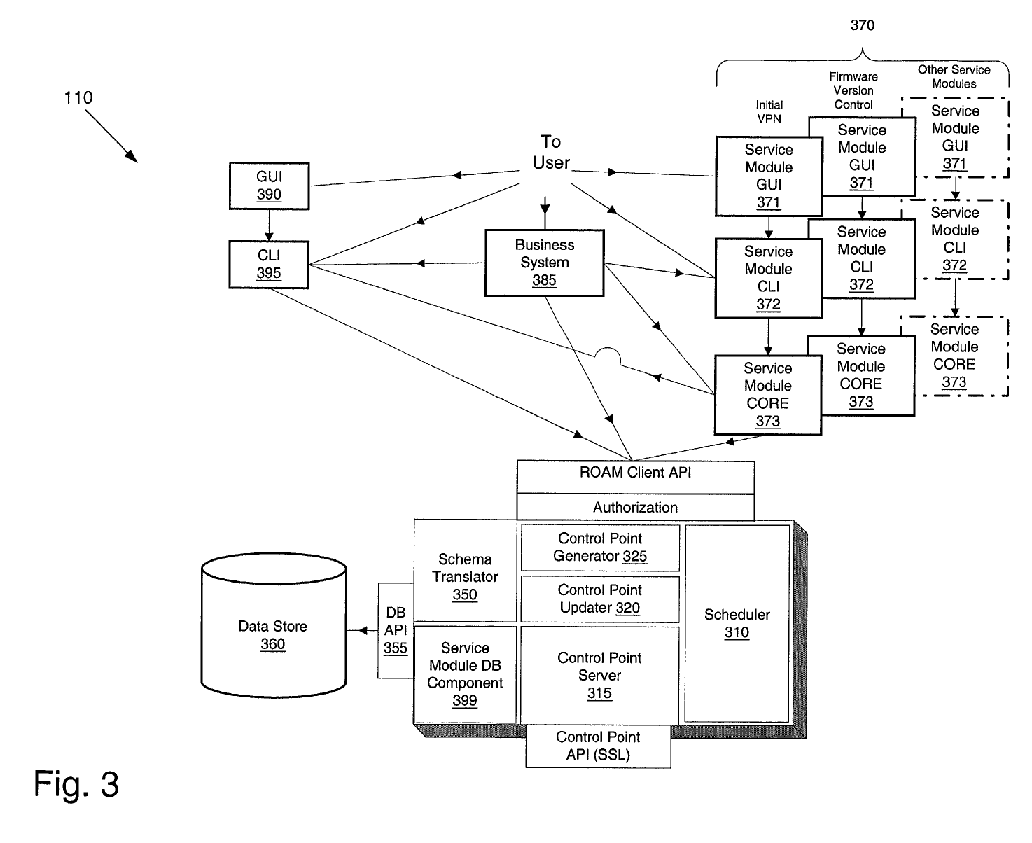

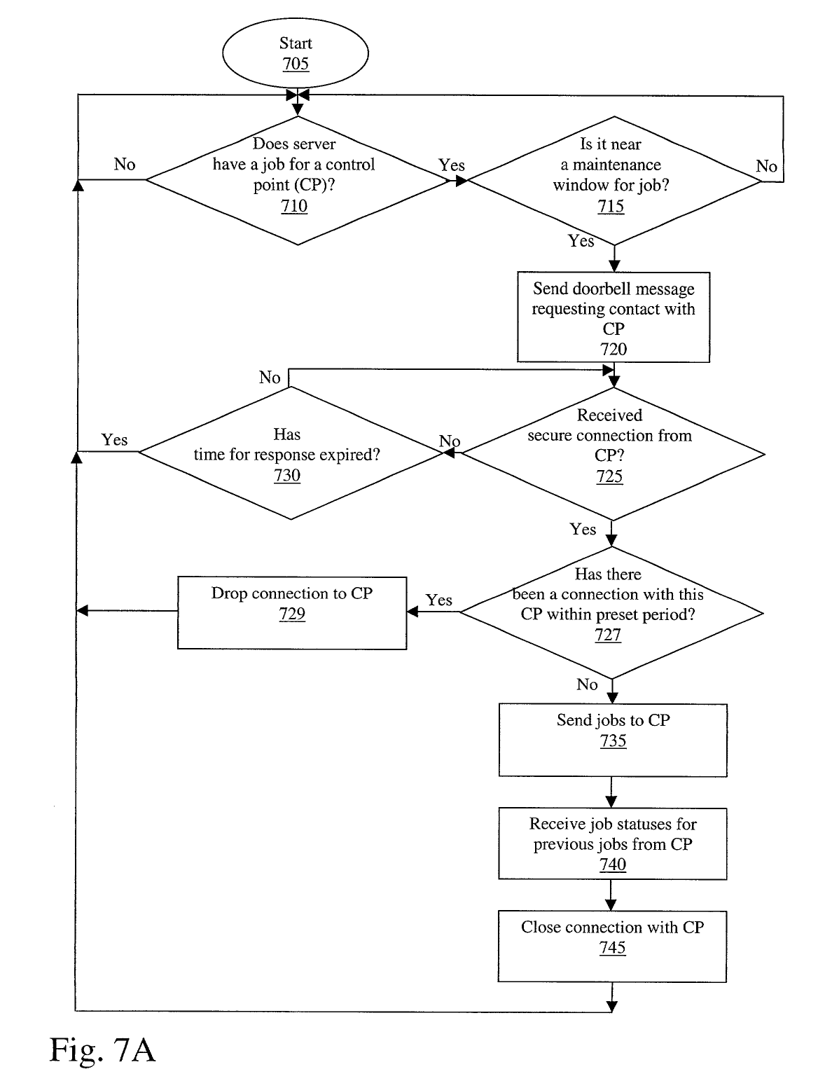

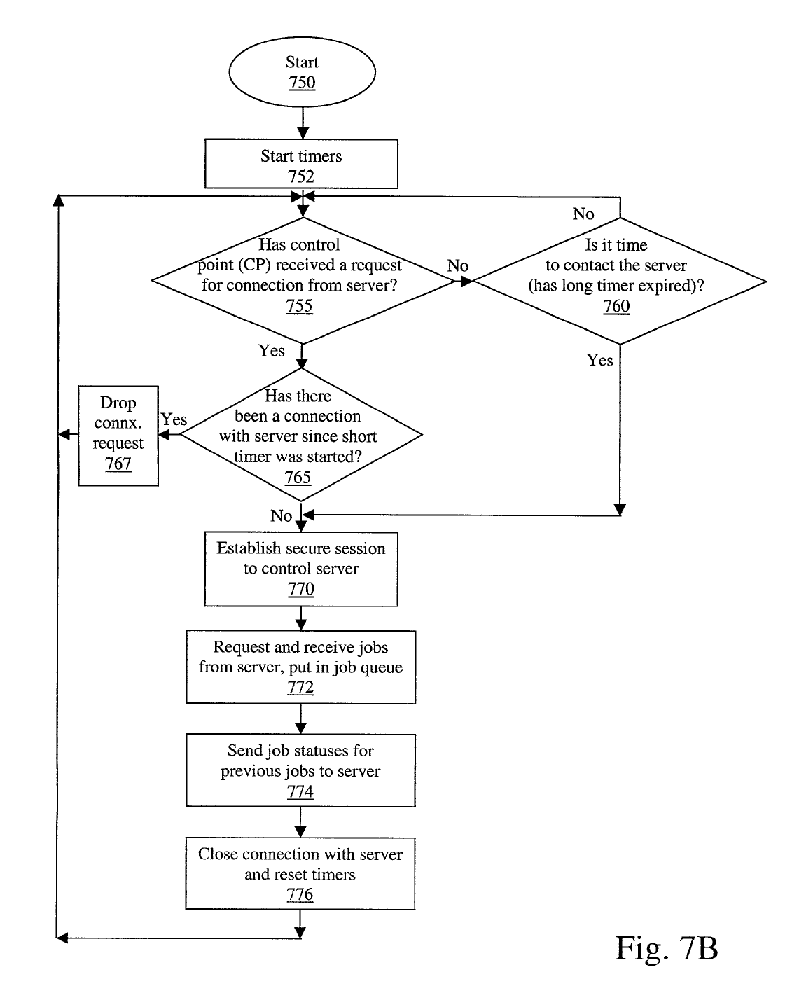

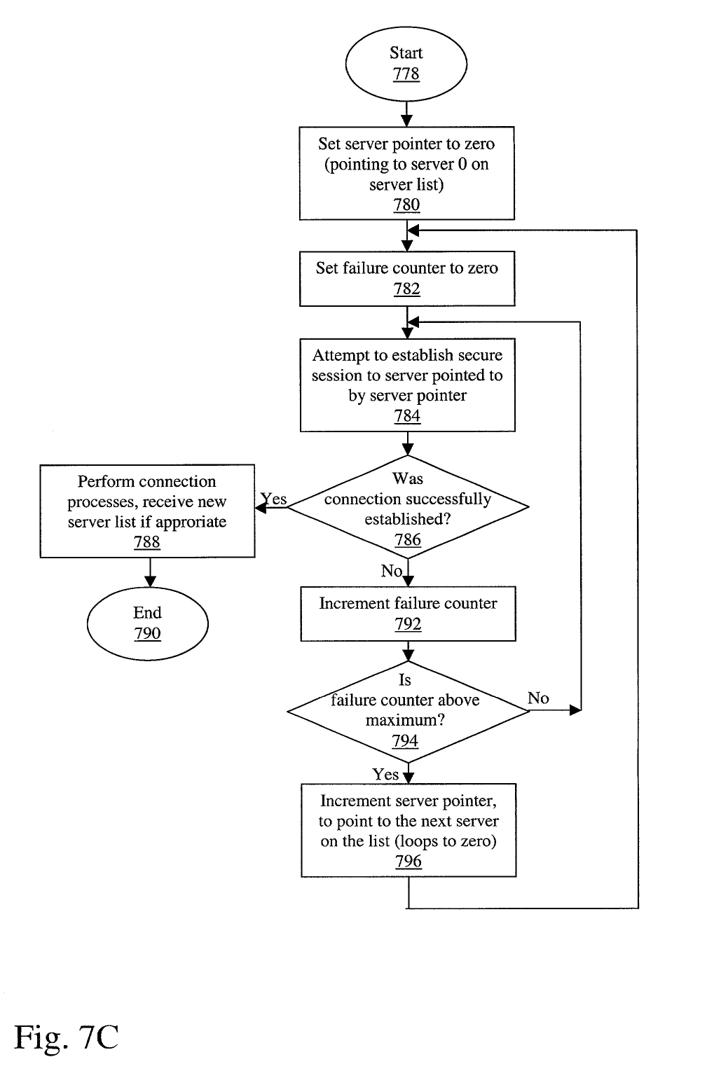

FIG. 3 is a block diagram of one embodiment of a control server. The control server 110 includes a scheduler 310, to schedule various interactions with control points (not shown), and to schedule maintenance windows for various devices. The control server 110 further includes a control point localizer 325, to generate new control points. For one embodiment, the control point localizer 325 may be used to generate the software for a localized control point on compact disk, floppy disk, or other media. This process is described in more detail with respect to FIGS. 7A and B.

Control server 110 further includes control point updater 320, which updates control points. The control server 110 treats the control point as a normal device. Control point server 315 interacts with the control point API 317, to send data to the control points and receive data from the control points. Generally, the data sent to the control points is a job or a requested file or other job relevant data, which defines certain activities to be performed by the control point within a certain maintenance window. The data returned by the control point is a report of status, i.e. whether the execution of the job was successful, and any accompanying information.

The control server 110 further includes schema translator 350 which interacts with the database API 355, which permits access to data store 360. For one embodiment, the data store is a SQL database. Alternatively, other types of data stores may be used. The database API 355 translates requests for the data store into the data store's interface language. The schema translator 350 presents the contents of the data store 360 in a hierarchical format. This permits logical interaction with the data store using command line interface 395, graphical user interface (GUI) 390, service modules, or business system 385.

The command line interface 395 allows the user to execute complex commands composed together via pipes. Thus, a complex set of commands, where the output of one command is designed to be the input to the next command, may define any action within data store 360. Similarly, the GUI 390, web based front-end, and/or business system 385 may permit the construction of complex commands that allow the user to make complex changes to the data store.

Scheduler 310 schedules the maintenance windows for each device, and access timing for each control point. The process of scheduling is described in more detail below.

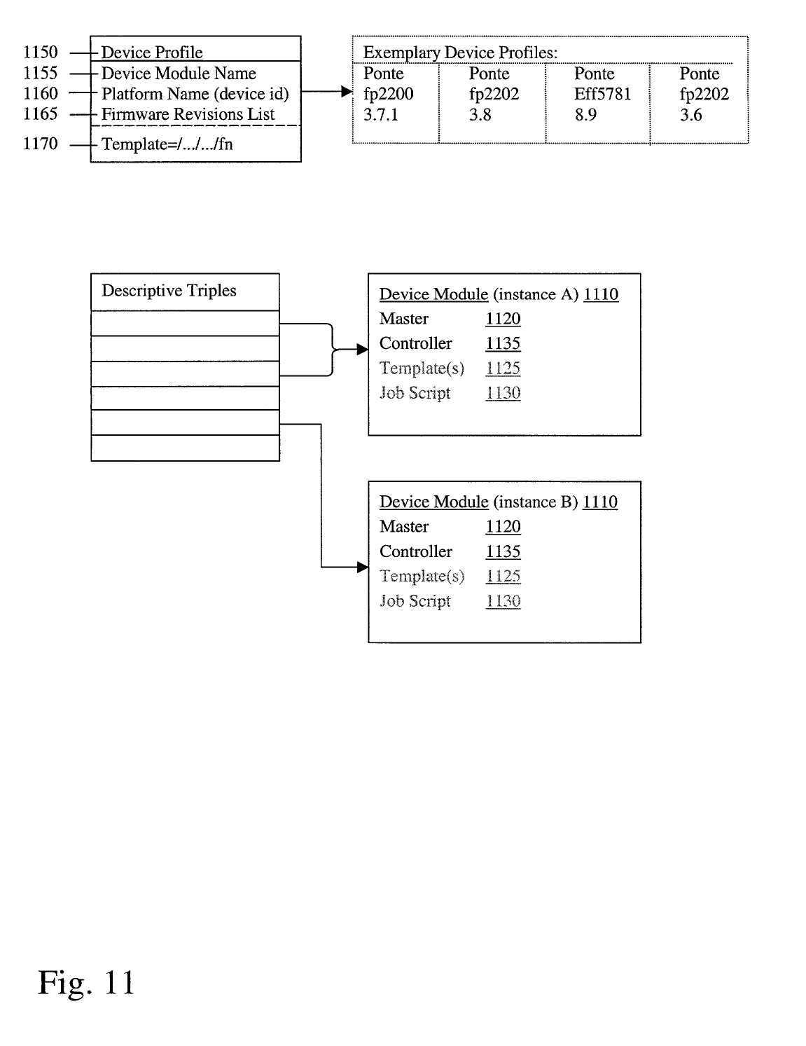

Control server 110 further includes a device module API, to interact with device modules 345. Device modules are used to generate jobs for devices. The device module is described in more detail below, in FIG. 11.

The client API permits access to the control server by various service modules. The service modules 370 define complex workflow or known relationship types between devices. For example, a service module 370 may be used for initial element activation. Initial element activation may include configuring and activating a DSLAM, a CPE, and various other elements. The order in which these elements are configured may be critical. The service module 370 tracks this data, and sends the data to be used to create the configuration information to the device modules 345 in the correct order, to force the correct configuration.

The service module 370 may include a separate graphical user interface 371, or command line interface 372. For another embodiment, the CLI and/or GUI of the service module 370 may be integrated with the CLI and/or GUI of the control server 310. The service module 370 may further, or alternatively, include a service module data store component 399. The service module data store component 399 interacts with schema translator 350, to recognize a specific change (or set of changes) to activate a service module. For example, a service module that defines a virtual private network (VPN) may have a data store component 399 to recognize if one of the devices within the VPN has changed its configuration. In that case, the other devices within the VPN must be alerted to this fact, to keep the VPN functioning. The service module 370 is activated by the data store component 399, and performs configuration analysis and job generation.

Various business systems 385 including web based front ends may address the control server 110. The client API may include an authorization layer, to verify that a service module business system, or user interface interacting with the control server 110 is authorized to do so.

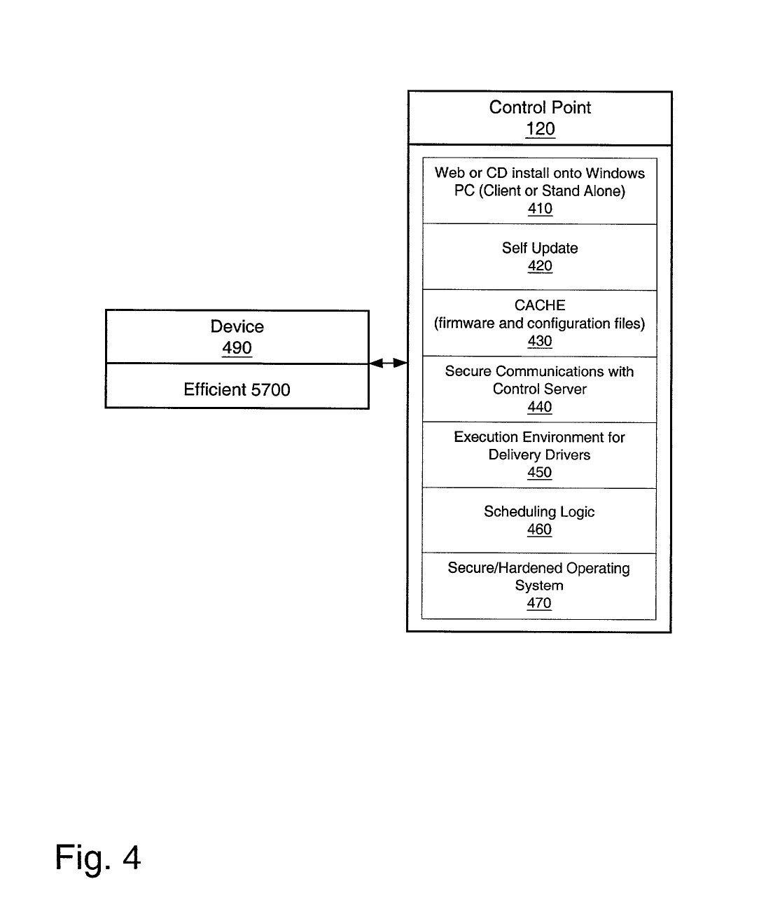

FIG. 4 is a block diagram of one embodiment of a control point. Control point 130 includes an installation 410. The installation is the control server-branded disk or other media, which is used to generate the control point 130. The control point 130 may be generated on a stand-alone device, such as a computer, a special purpose appliance, on the same device as the control server or some other server, or a client device that may be used for other purposes. The control point 130, for one embodiment, installs its own operating system. For one embodiment, for devices that are not dedicated devices, the device may be made dual-boot, such that the original operating system is maintained on one portion of the system, while the operating system on which the control point 130 is running is installed on a separate portion. For one embodiment, the control point 130 is run on a specially hardened NetBSD operating system 470. For one embodiment, the hardening of operating system 470 includes making it more stable, and increasing security.

For one embodiment, the control point's installation 410 may be over a Windows operating system, or another type of operating system. For another embodiment, the control point's installation 410 may be over a Unix variant or Unix-like operating system, such as Linux, Solaris, or AIX.

The self-update logic 420 in control point 130 manages the updating of the control point itself.

The cache 430 stores firmware versions, configuration files, and support files, which are sent to the control point 130 as a job. This permits the sending of smaller jobs, since only a reference to the appropriate files needs to be made. Thus, if 100 devices are upgraded, the actual firmware upgrade file, which may be quite large, need only be sent once from the control server to the control point.

Secure communication mechanism 440 uses a key exchange to communicate with control server 110 (not shown). The secure communication mechanism 440 further generates the private key for the control point 130. For one embodiment the secure communication mechanism 440 further uses an initial one-time password (nonce) to connect to the control server for the first time.

Execution environment for delivery driver 450 is where the indicated processes/jobs are executed. The execution environment 450 also executes the JobScript within the job to interact with device 490 to update/configure/obtain information from the device 490, as indicated by the job.

Scheduling logic 460 maintains the maintenance windows for each device that the control point 130 has a job for. Scheduling logic 460 further maintains the control point in clock sync with the control server. This is useful because as long as the control server is kept in good time sync with the world, that the control points are also, which ensures predictable and correct Job execution scheduling. It is also useful because it permits simple verification of what action occurred at what time. This may be useful, for example, in an evidentiary situation. Scheduling logic 460 further maintains a timer, to have the control point 130 contact the control server on a regular basis, if no request for connection is received from the control server. This is described in more detail below with respect to FIGS. 7A and B.

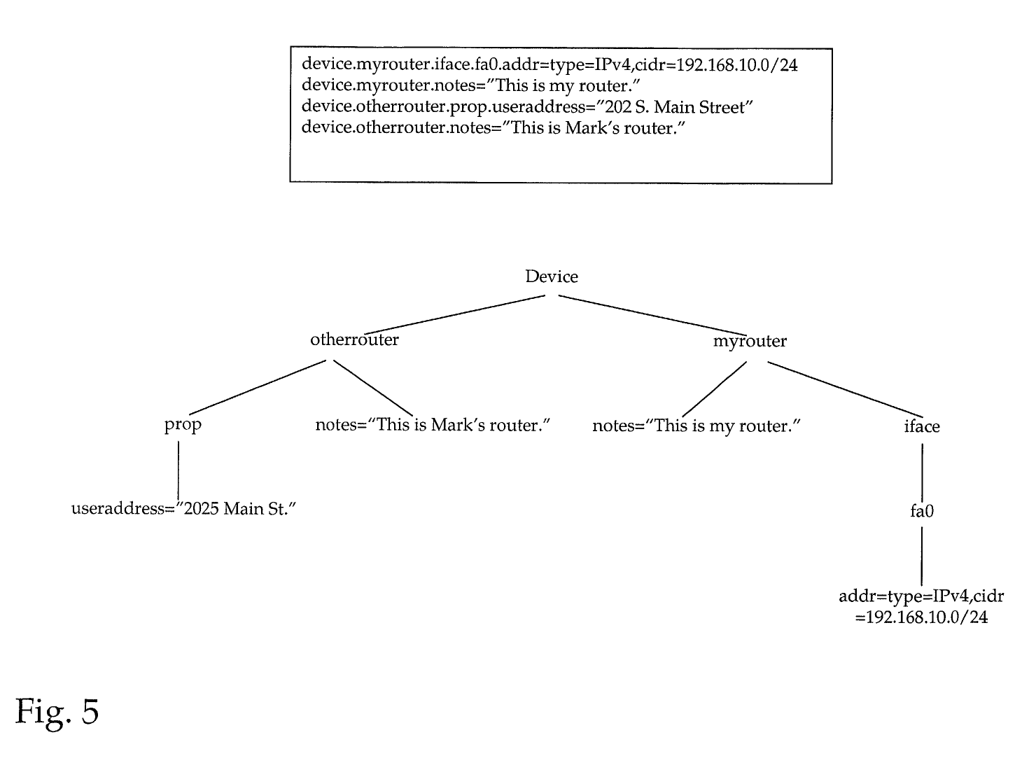

FIG. 5 illustrates one embodiment of the hierarchical structure of the data store. The hierarchical layout of the data store creates a data store tree that is simply configured. Statements 510 include four statements defining various data within the data store. For example, statement 1 identifies a device (myrouter), having an interface (fa0), having a particular address. As can be seen in tree 520, the device identification branch includes myrouter, and other router, while the interface identification includes interface fa0, which further includes the particular address identified in the above statement.

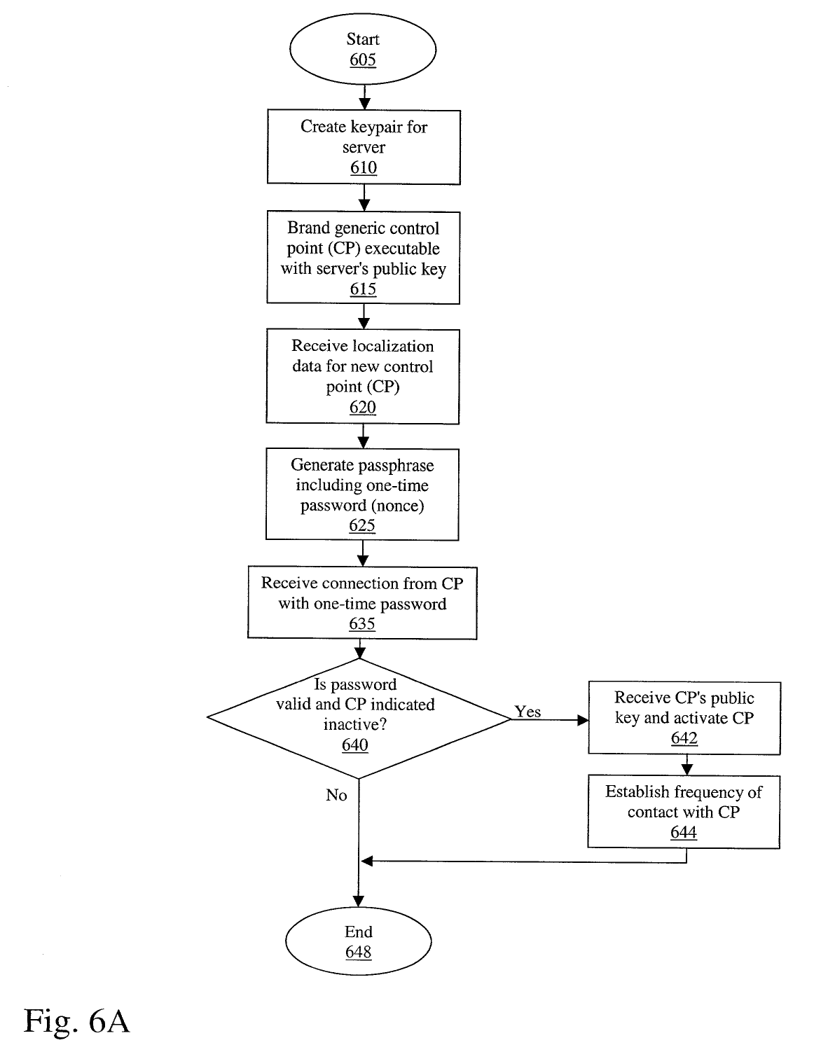

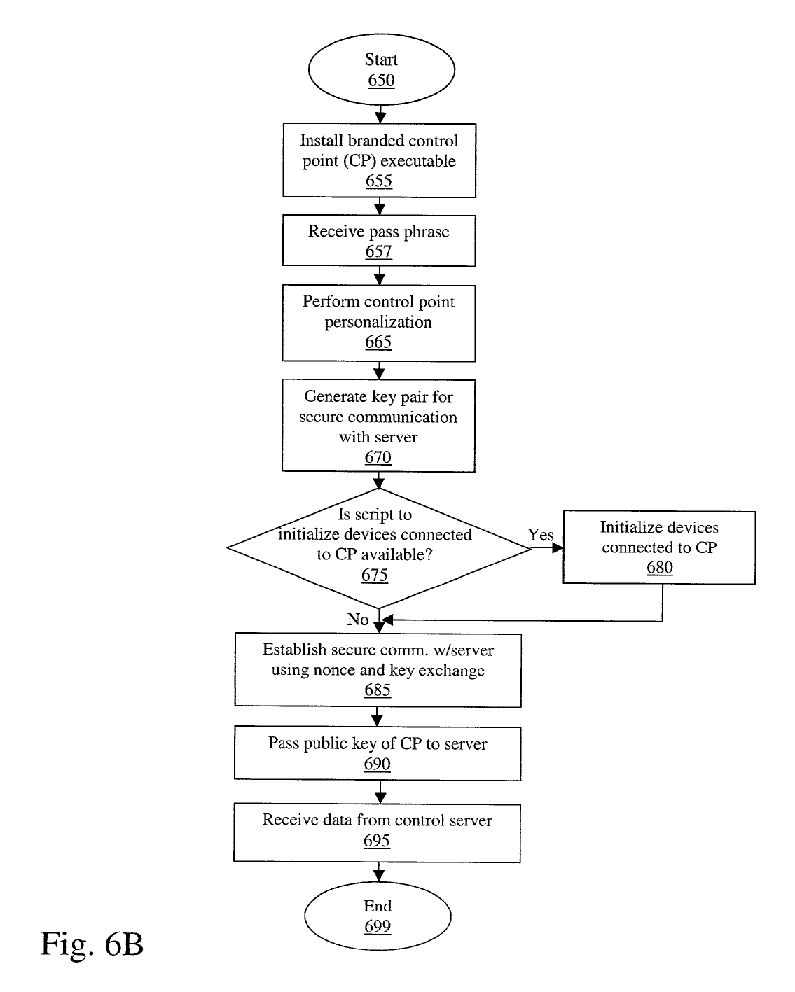

FIG. 6A is a flowchart of one embodiment of installing a control point, from the control server's perspective. FIGS. 6A and 6B show one embodiment of the process of installing and starting up a new control point from the perspective of the control server and the control point. FIG. 6A illustrates the control server's perspective.

The process starts at block 605. A key pair is generated for the control server 610, and a generic control point executable is branded with the control server's public key, at block 615. These two steps take place once, when the control server is initialized. For one embodiment, by branding the control point executable with the public key, the control point is permanently associated with a particular control server. For one embodiment, in order to move a control point from a first control server to a second control server, it must be reinstalled, with the branded executable of the second control server. Alternatively, the control point may be told in some trusted way about the other control server. For another embodiment, the second control server must have the same public/private key pair as the original control server. This increases security.

At block 620, IP localization data is received for a new control point. IP localization data defines the future IP address, network mask, and gateway address of the new control point. This data is received from a user, or from an external program.

At block 625, a passphrase is generated. The passphrase includes a unique one-time password. The passphrase further may include the IP localization data for the control point. For one embodiment, the passphrase comprises a set of words in the English language. This simplifies memorization and communication of the passphrase, and makes typos less likely. For one embodiment, the words are each four-letter words. Of course, the dictionary used for this may be changed, to any other language. Thus, the passphrase may be in any language, may have any number of words, and may have words of any particular length, or of a variety of lengths. This permits the use of a more complex passphrase that is still useable by a normal user.

The passphrase is then displayed to the user, and someone installs the control point, and enters the phrase to activate the control point. Because the passphrase is words in a language the users speak, it can be easily communicated over the telephone or another link to a remote administrator or user who actually performs the activation.

At block 635, the connection from the new control point—recently installed by the user—is received at the control server. The connection uses the one-time password provided with the passphrase.

At block 640, the control server determines whether the control point described by the passphrase is valid and inactive. The passphrase includes a control point number encoded within it. During the initial connection, the control point uses this number. If the number is invalid—i.e. is not in the control server database—, or the control point corresponding to the number is already active, this onetime password is not useable. In that case, the process continues to block 648 and ends without initializing the new control point.

If the passphrase is valid, and the control point described by the passphrase has not been seen before, the process continues to block 642.

At block 642, the control point's public key is received, and the control point is activated. The control point is added to the list of control points that can be used to control devices. At block 644, the frequency of contact with this control point is established. For one embodiment, the control point is contacted by the control server on a regular basis. However, if the control server has not been in touch with a control point within a preset period of time (set at this point), the control point initiates contact. At block 648, the process ends.

At this point, the control server is aware of the control point, and can use the control point to contact various devices that may be reached through control point.

FIG. 6B is a flowchart of one embodiment of installing a control point, from the control point's perspective. FIG. 6B illustrates the control point's perspective. The process starts at block 650.

At block 655, the localized control point executable is installed on a system. Localization in this context refers to localization for the particular control server that will be the control server for this control point. The term “branding” also refers to the fact that the control point will only be useable by a particular control server that it is localized by. For one embodiment, the control point is installed by a human. As discussed above, the device may be a standard personal computer, which may be used as a dedicated control point or may be a dual-function system. For another embodiment, the control point may be a special function appliance, having only those elements needed to function as a control point.

At block 657, the process receives the passphrase from the installing human. The passphrase encodes within it the localization information for the control point, as well as a one-time password.

At block 665, the control point is personalized. Personalization includes setting up the Internet Protocol (IP) settings. For one embodiment, this further includes having the control point test its network connection using the IP localization data from the passphrase.

At block 670, a new key pair is generated for secure communication with the control server. This key pair is used by the control point from this point forward to securely communicate with the control server.

At block 675, the process tests whether there are any jobs for any devices coupled to the control point. The jobs may be encoded within the passphrase, or may be transferred alongside it. If there are jobs available, at block 680 devices for which there are jobs are initialized. For one embodiment, this is done within one of the maintenance windows of the device, as will be discussed in more detail below. The process then returns to block 685. If no jobs are available, the process continues directly to block 685.

At block 685, secure communication is established with the control server, using the one-time key, and a key exchange. For one embodiment, the key exchange is a Diffie-Hellman key exchange using session keys. The underlying connection is established using the one-time password, or nonce. Using that underlying secure connection, a session key is exchanged, and used for further communication.

At block 690, the public key of the control point is passed to the control server over the secure connection created in block 685. This public key, generated at block 670 above, is used for creating secure communication channels in the future. This type of public key based secure communication is known in the art.

At block 695, various data is received from the control server. This data may include a maintenance schedule for the control point itself, and various jobs for various devices. The control point then disconnects from the secure communication, and the process ends at block 699.

FIG. 7A is a flowchart of one embodiment of communication between the control server and the control point. The process starts at block 705. This process is a continuous process, in which the control server determines whether it has anything to say to a control point, and then communicates with the control point. Note that although certain processes are illustrated as loops, they may be interrupt driven. This is true for all of the processes shown.

At block 710, the control server determines whether it has a job for a control point. If not, this process continues to wait and check, until a job is found.

At block 715, the process determines whether it is sufficiently near the maintenance window of the job to send the job. In general, the job is sent shortly before it is to be executed. If not, the process returns to block 710, to evaluate all outstanding jobs. Alternatively, the job may be sent at a job send window, as specified by the request that generated the job. For example, jobs may be sent months in advance. Since the control point includes its own scheduler, it can take care of timing the update/configuration process as specified by the job.

Note that the process shown by blocks 710 and 715 may be combined into a single query, of whether there is a job due to be sent. Furthermore, this process may be spawned only if there is at least one outstanding job. Alternatively, this may be an interrupt driven process, in which the processing of the control server is interrupted when the conditions are correct, i.e. there is a job for a control point and it is appropriately near the maintenance window allocated for the job.

If it is sufficiently near the maintenance window for the job to send it, the process continues to block 720.

At block 720, a doorbell message is sent to the control point, requesting contact. For one embodiment, the doorbell message is an empty UDP packet sent to a particular port of the control point. For another embodiment, doorbell message is an attempt by the control server to open a TCP connection to the control point, at a predefined port address. This indicates to the control point that a request for contact has been received.

The process then returns to block 710. The process also continues to block. The process shown in blocks 710-720 is independent from the processes described below, in blocks 725-745.

At block 725, the process determines whether a secure connection has been received from the control point. This monitoring is continuous, whether or not a request for communication has been sent. If no communication has been received, the process continues waiting for communication. This too may be an interrupt driven process.

If communication has been received, the process continues to block 730. At block 730, the process determines whether there has been a communication with this particular control point within the previous preset period. For one embodiment, the preset period may be a minute. If there has been such a communication, the process continues to block 733, and the connection is dropped. The process then loops back to block 725, to await new communication. This prevents denial of service (DoS) attacks against the control server, since only one connection per minute may be originated from any control point. Thus, if a control point is compromised, it is still unable to take down the control server.

If there has been no communication within the preset period, the process continues to block 735.

block 735, any jobs for the control point are sent to the control point as jobs. Such a job may include a JobScript, configuration elements and configuration files, and supporting files. The JobScript, configuration, and supporting files may simply be identifiers, permitting the control point to fill in data from its cache, or request the needed data during the execution of the JobScript. This will be described in more detail below.

At block 740, job statuses for previous jobs executed by the control point are received. Job status may include a transcript of communication between the control point and device, a result code, an explanation for failure to successfully execute the JobScript, and any accompanying information.

The communication is then completed, at block 747, and the process returns to waiting for a secure communication from a control point.

FIG. 7B is a flowchart of one embodiment of the process of communication between the control server and control point, from the control point's perspective. The process starts at block 750. At block 752, a long timer is started to monitor a period since the server has last contacted the control point. A short timer is started whenever a connection is received from the server, to monitor whether the connections are too frequent.

As described above, portions of this process may be interrupt driven. This permits the control point to be in power save mode, if no jobs are due, and no connections are received. In that instance, the system may have a “wake up on timer” to check whether any requests have come in. Alternatively, the system may have a “wake on LAN” setting, which automatically wakes up the control point whenever a network connection request is received.

If there is no request for connection, the process continues to block 760.

At block 760, the process determines whether it is time to contact the control server. The control point periodically contacts the control server, if no connection has been received within a preset period of time. For one embodiment, this time may be 15 minutes, an hour, or any other time frame. For example, a control point may be behind a firewall or a network address translation (NAT) device, and thus the control server may not be able to contact the control point. This process makes sure that the control point and control server communicate on a regular basis. If it is not yet time to communicate with the control server, the process loops back to block 755. Note that the processes shown in blocks 755 and 760 are independent, and may be executed in any order.

If the control point has received a request from the control server, the process continues to block 765. At block 765, the process determines whether there has been a connection request within a preset period of time. If so, the control point doesn't acknowledge the connection request, i.e. the control point passively ignores the connection request at block 767, and the process returns to block 755. This prevents a denial of service (DoS) attack on the control point, since only one connection request per the preset period of time is acknowledged. For one embodiment, the preset period of time may be one minute.

If no connection has been received within the preset period of time, the process continues to block 770. If, at block 760, the process determined that it was time to contact the control server, the process continued directly to block 770.

At block 770, the control point establishes a secure session with the control server. For one embodiment, the establishing of the secure session uses the public/private key pairs of the control point and control server. FIG. 7C illustrates in more detail the process of establishing a connection with the control server.

At block 772, the control point requests and receives jobs from the control server, and puts the jobs into a job queue. For one embodiment, the job queue is ordered by maintenance window, i.e. the time at which the job should be executed.

At block 774, the job statuses for previous jobs that have been completed are returned to the control server. At block 776, the connection with the control server is dosed, and the timers are reset. The process then returns to block 755, to test whether a connection request has been received from the control server.

FIG. 7C illustrates one embodiment of establishing connection to the control server, including control server failover, from the perspective of the control point. The process corresponds to block 770 of FIG. 7B, establishing a secure session with a control server. The process starts at block 778.

At block 780, the server pointer is set to zero, to point to server zero on the server list. The control point has a server list, which lists, in order, the control servers which are available to the control point. The server list has at least one server on it. However, for one embodiment, at least two servers should be on the control server list.

At block 782, the failure counter is set to zero.

At block 784, the process attempts to establish a secure session with the control server pointed to by the server pointer. Thus, if this is the first pass through, the pointer points to server zero (see block 780).

At block 786, the process determines whether the connection to the server has been successfully established. If so, the process continues to block 788. At block 788, the standard connection procedures, described above with respect to blocks 772-776, are executed. If appropriate, a new server list is received. For one embodiment, a new server list may be provided if the control server reached is not server zero, or if the server(s) formerly on the list are no longer available, or no longer the preferred server. The process then ends at block 790.

If the connection is not successfully established at block 786, the process continues to block 792. At block 792, the failure counter is incremented. The failure counter counts the number of unsuccessful connection attempts that have been made to this server.

At block 794, the process determines whether the failure counter is above a maximum count. In general, the system performs a preset number of connection attempts. If the failure counter has not yet reached the maximum, the process returns to block 784, and the system once again attempts to contact the server. For one embodiment, there may be a built-in wait prior to reattempting the connection.

If the failure counter is above the maximum, the process continues to block 796. At block 796, the server pointer is incremented, to point to the next server in the server list. For one embodiment, the server pointer loops to zero. Thus, for example for a control point that has three servers on the server list, the control point would initially attempt to connect to server zero, then server one, then server two. If server two is not available, the control point attempts to connect to server zero again. This process loops until the control point is able to connect to one of the servers on the server list. For one embodiment, there may be a short wait, prior to reattempting the servers on the list (e.g. at loop-over).

In this way, the process can gracefully failover to a new server, without requiring that the control point have any additional intelligence, beyond a server list provided by the control server, a server pointer, and a failure counter.

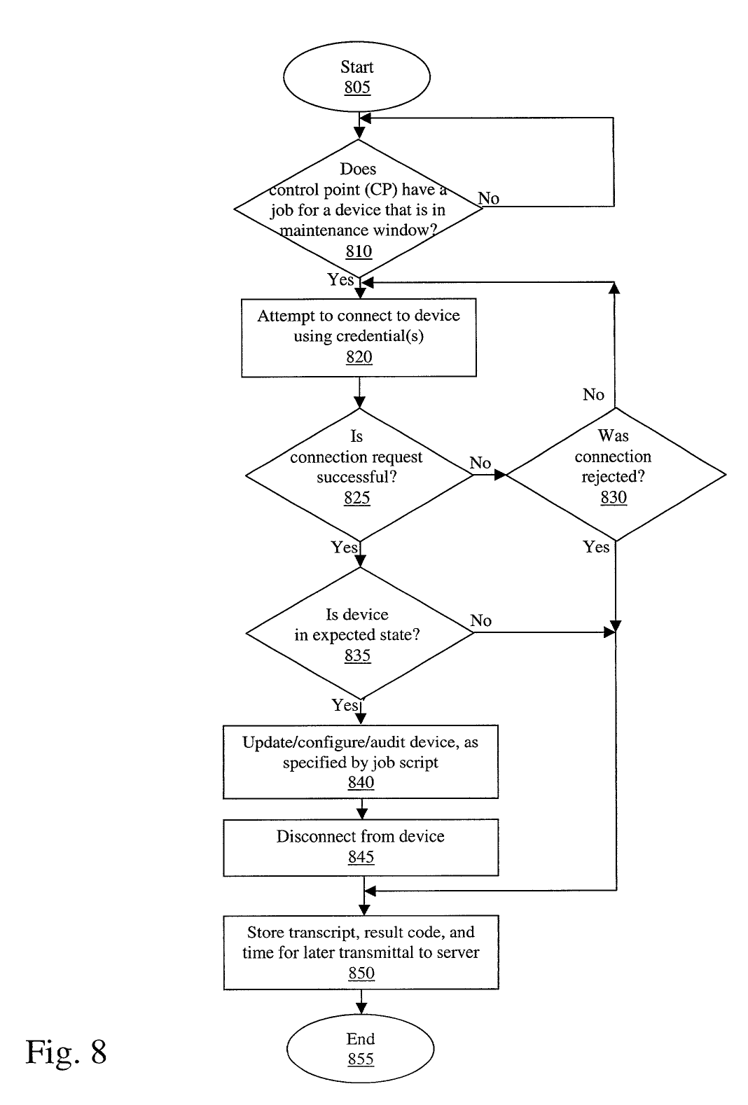

FIG. 8 is a flowchart of one embodiment of updating a device from a control point. The process starts at block 805. At block 810, the process determines whether the control point has a job for a device that is in its maintenance window. Each job has associated with it one or more maintenance windows, during which times the job may be performed. Thus, this process determines whether there are any jobs that are scheduled for the current time. This process uses the internal scheduling logic of the control point, which permits the control point to determine whether it is time to perform a job.

If there are no jobs that are to be performed, the process returns to block 810, to wait. For one embodiment, this is an interrupt driven process in which, when a maintenance window for a device opens, the control point is interrupted. For another embodiment, the control point periodically wakes up, and tests whether there are any current jobs in the maintenance window. If there is a job in the maintenance window, the process continues to block 820.

At block 820, the control point attempts to connect to the device. For one embodiment, the connection may be through a direct connection, such as a serial connection. For another embodiment, the control point may use the device credentials to connect to the device. The credentials may be a public key, a password, or another type of credential to access the device.

For one embodiment, the credential is a password. The control point initially uses the last password for the device. If the last password fails, and a new password exists that is not identical to the last password, the control point may attempt to use the new password. If the new password fails, or there is no new password, the control point may attempt to use the factory default password for the device. Note that this process of successively attempting passwords is specified by the JobScript, and may be skipped if the JobScript does not wish to try any other password than the current password.

At block 825, the process determines whether the connection was successful. If the connection was not successful, the process continues to block 830.

At block 830, the process determines whether the connection was rejected. If the connection was rejected—e.g. the control point connected to the device and provided a credential, and the device rejected the connection—then there is a problem in the interaction between the control point and device. Therefore further attempts at connection would not be useful. Thus, the process directly continues to block 850, where the transcript of the failure and the result code is stored, for later transmittal to the control server. The process then ends at block 855.

If, on the other hand, the connection failed but not as a result of a rejection, the process returns to block 820, to attempt to connect to the device again. For one embodiment, the process waits for a short timer to expire prior to re-attempting the connection. For one embodiment, after a set number of attempts, the process may declare the connection unsuccessful. The process then continues to block 850, to report on the attempted connections.

If the connection request was successful at block 825, the process continued to block 835. At block 835, the process determines whether the device is in the expected state. The expected state includes configuration, firmware, etc. If the device is not in the expected state, the process continues directly to block 833, setting the result code to error, and then to block 850, to store a report on the status of the device. If the device is in the expected state, the process continues to block 840. Note that this process is implemented in the JobScript, and may be skipped. Thus, for one embodiment, the process may continue directly from block 825 to block 840.

At block 840, the device is updated, configured, and/or audited as specified by the JobScript, using the configuration files and supporting files as needed. For one embodiment, the device may also be tested, to verify that the updating/reconfiguration/audit was successful. Auditing a device may include obtaining a copy of all the files or a subset of the files and/or data on the device, obtaining a checksum of the firmware files, or in another way determining the state of the system. For one embodiment, audit jobs may be generated on a regular basis automatically.

At block 845, the control point disconnects from the device, having successfully executed the changes specified by the job.

block 850, the control point stores the results of the execution. For one embodiment, the results include a transcript of the interaction between the control point and the device, a result code (i.e. success or failure), an explanation of the result if the result code indicates a failure, and a time. The time allows the control server to track exactly what changes were made when to which device. For one embodiment, all control points are synchronized to the control server, to permit determination of the exact time when any update/configuration change occurred. For one embodiment, this synchronization is sub-second synchronization. The process then ends at block 855.

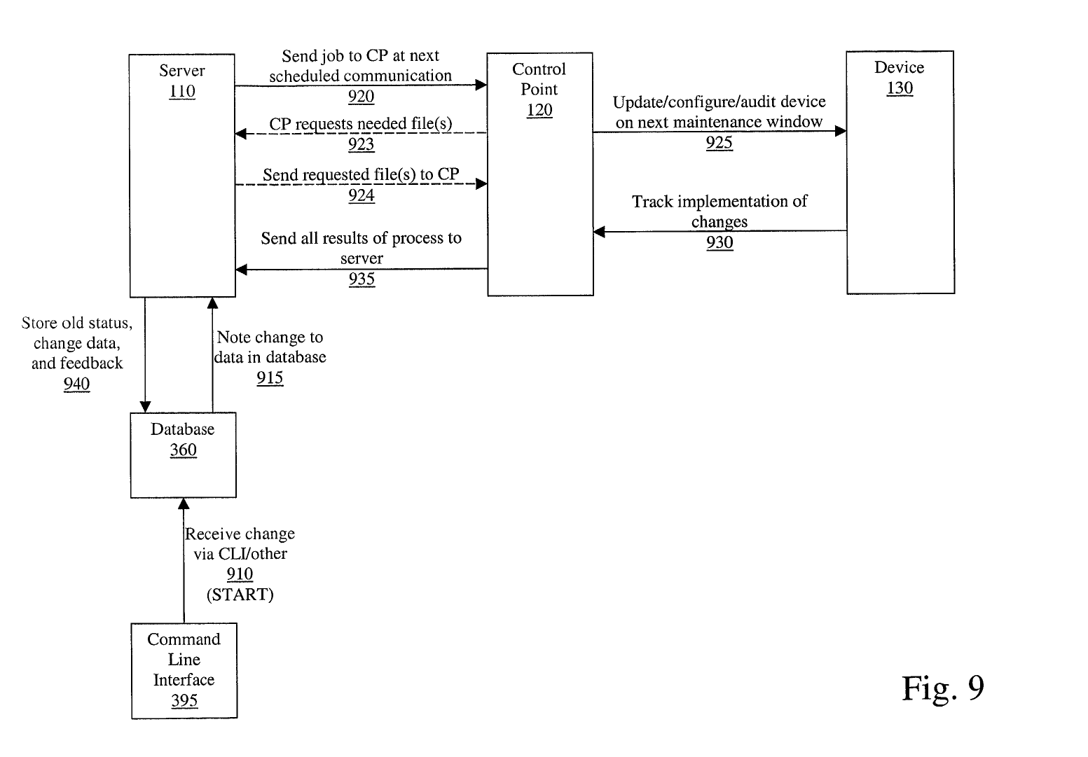

FIG. 9 illustrates one embodiment of command flow-through from the data store to a device. The command line interface 395 permits a user to enter various changes to data store 360, show as message 910. As described above, command line interface 395 permits the use of complex, pipelined syntax. The communication shown as message 915 alerts the control server that a change has been made in the data store. For one embodiment, this is not an actual communication, but rather an automatic event triggered by the change. For one embodiment, the system may be set up to automatically generate changes in the device profile periodically. For example, periodic automatic audits may be set up, by setting up a batch file or other self-executing file that periodically triggers a “new audit needed” note, or expires an old audit validity tag, or in a similar way requires a new audit to take place. Such an automatic change triggers the same message 915 as a change made via the CLI or other UI.

The control server 110 then generates a job for the change, and sends the job to the control point at the next scheduled communication, shown as message 920. The job includes a JobScript, a data file, lists of supporting files, and a time to execute the job, i.e. maintenance window. The job is also pushed back to the data store, to keep the data store up-to-date, shown as message 940.

The control point 120 executes the job at the appointed time, and updates the device 130, shown as message 925. For one embodiment, if the control point determines if the identified supporting files are in the control point's cache. If the supporting files are not in the cache, the control point determines which supporting documents, firmware copies, or other items are needed. The control point 120 then requests the needed files, shown as message 923. This data is returned by the control server, shown as block 924. For one embodiment, the control point may suspend execution of the JobScript to request such files.

e control point 120 returns the results of the updating/configuration process to the control server, shown as block 935. The results are also added to the data store, shown as message 940. In this way, changes made by the user using CLI 395 flow through the data store to generate an actual change in the device 130.

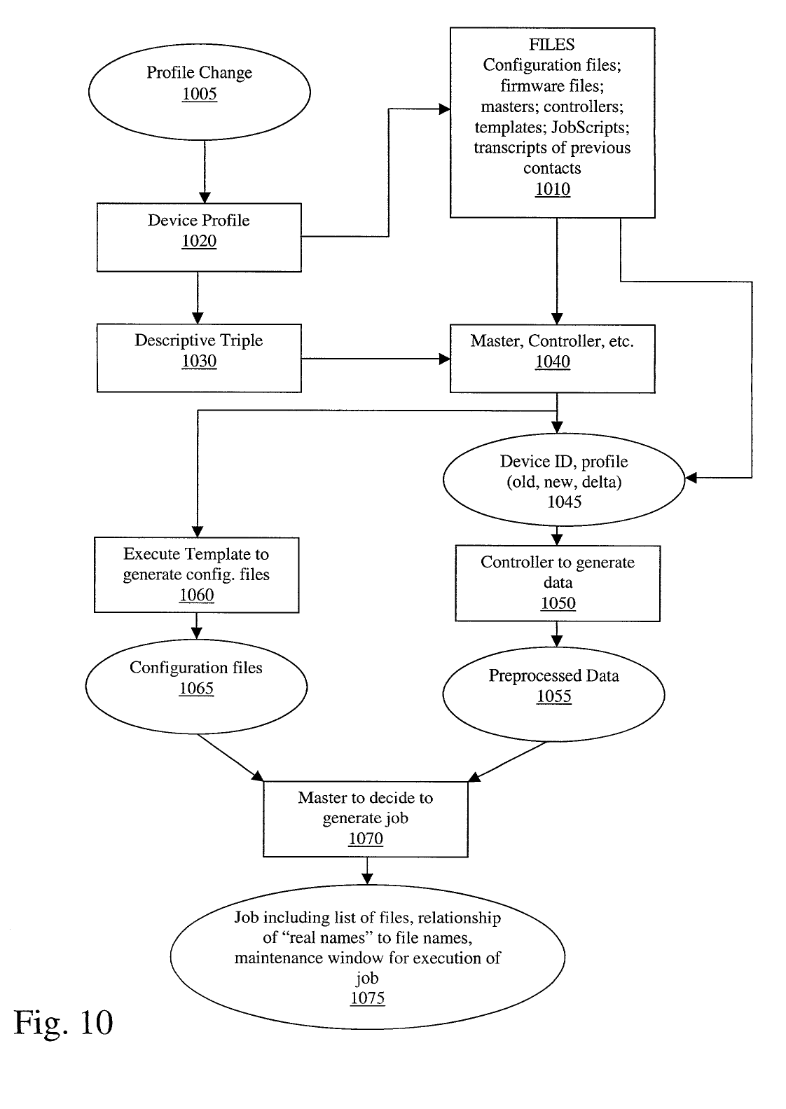

FIG. 10 illustrates one embodiment of generating the data sent by the control server to the control point, for command flow-through. The process is initiated by a change 1005 in the data store 1010, to a device profile 1020. This change may be made using the command line interface (CLI), a graphical user interface (GUI), or another type of interface, including an interface in a service module.

The device profile 1020 thus changed identifies a descriptive triple, which in turn identifies a master, controller and possibly other elements 1040. As discussed below, the descriptive triple 1030 points to one master and one controller, and may further point to templates, JobScripts, and other elements.

The device ID and device profile are passed to the controller, to generate data for the master. For one embodiment, the device profile data passed to the controller includes the original device profile, the new device profile, and a delta, indicating the change(s) in the device profile.

If a template is indicated by the device module 1040, the template is executed 1060, to generate configuration file(s) 1055. For one embodiment, if there is a template specified by the device profile, it overrides the template identified by the descriptive triple.

The configuration files 1055 and preprocessed data generated by the controller 1050 are passed to the master 1070. The master then decides the course of action. The master may determine that no job needs to be generated, since the changes made in the profile do not need to be propagated to the device. For one embodiment, all changes to the device profile trigger this process. For example, the change of a comment may trigger this process. The master may thus decide that the device need not be updated/changed/audited as a result of the change to the device profile. If, however the master decides that the device should be changed/updated/audited, a job is created.

The job includes a maintenance window, a list of required files, and a correspondence to the “real names” of the list of required files. Thus, the job may be quite small. If the control point cache has the files required by the job, then the job is all that needs to be sent. However, if the control point does not have one or more of the required files, it requests the files from the control server, when the job is being executed.

FIG. 11 is a block diagram of a device module and a descriptive triplet embodying the device module. A Device Module 1110 is a list of name-to-filename associations. A Device Module 1110 must include a Controller 1135 and a Master 1120. The Controller 1135 preprocesses data that is derived from the Data Store, and the Master 1120 uses the data created by the Controller 1135 to create the Job. The device module 1110 may further include one or more templates 1125 and a JobScript 1130, if the Master 1120 uses templates and/or a JobScript.

The template 1125 takes data from controller 1135 and creates a configuration file and/or enough data for the JobScript 1130 to make the requested change to the device state. The controller 1135 manipulates the data from the device profile 1150 and other sources to create data for use by the templates 1125, in accordance with the modification indicated by the user/service module.

A template 1125 may invoke one or more templates, which may in turn invoke other templates. Similarly, controllers 1135 may invoke other controllers, and so on.

A descriptive triple 1150 points to the device module 1110. The descriptive triple 1150 includes a device model name 1155, a platform 1160, and a firmware revision 1165 for which this is the appropriate device module 1110. The descriptive triple 1150 may further include a template. The template referenced in the device profile 1150 overrides the template referenced in the device module 1110.

A plurality of descriptive triples 1150 may point to the same device module 1110. This generally occurs when the devices and firmware configurations are very similar. The descriptive triple 1150 defines the language which may be used to access the devices which are described the by descriptive triple 1150.

Note that the device module 1110 shown is an example only. A device module 1110 need only include a master 1120 and a controller 1135 to process data. The other elements may be added, if they are used by the controller 1135 and/or the master 1120.

Firmware is managed separately from Device Modules. The firmware file list 1170 is key/value pairs indexed on a double—platform, and firmware revision.

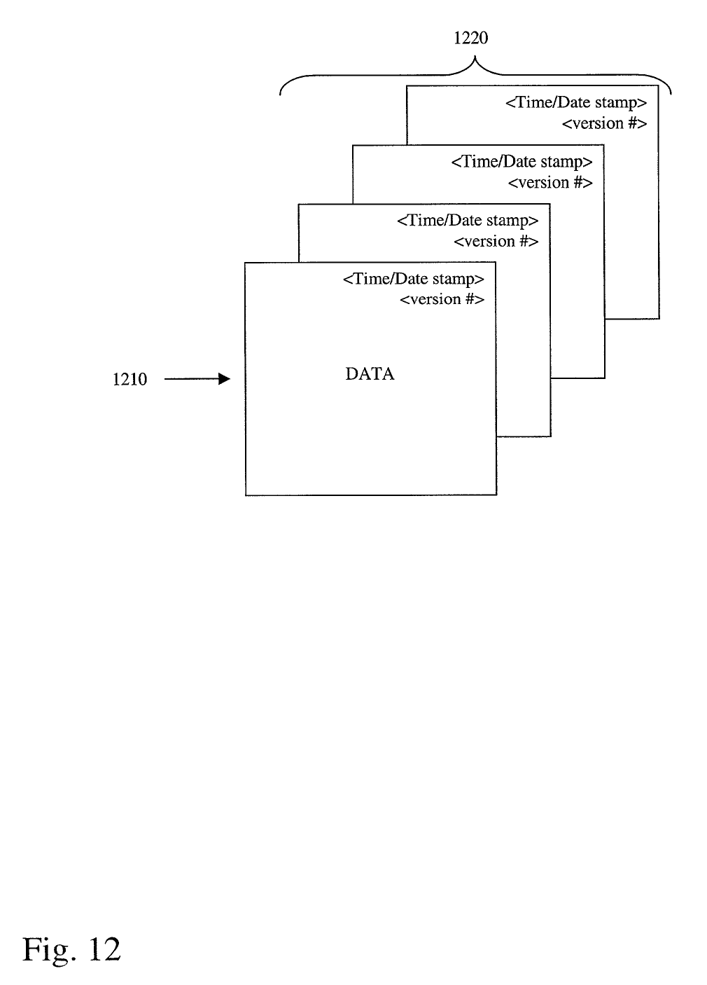

FIG. 12 illustrates one embodiment of the history/versioning process. A data store entry 1210 is shown. The data store entry 1210 can be any type of data, including configuration information, device profile information, transcripts, pointers to files (each file having a version), and pointers to template files. Each data store entry 1210 has a version number and a time/date stamp. The data store entry 1210 has associated with it historical data 1220, e.g. prior versions of the data.

Each change to the data store entry 1210 generates a new “current version” of the entry, and stores the previous version as historical data 1220. For one embodiment, the version number is incremented by one, and versions are integers. The time attached to each entry indicates when the change was made. In this way, the changes to the data store entry, to device profiles, templates, configurations, etc. can be tracked. For example, if a problem occurs at a certain time, all records changed just prior to that time may be examined to determine the source of the error. Furthermore, a previous configuration may be reconstructed, using this data store. Additionally, using the device profile data, appropriate configurations for different devices may be generated, using the data store.

The process described above permits control of a complex network. The flexibility and configurability of the system allows a user to alter the data structures used, alter the interfaces, and otherwise make the best use of this system.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

### Appendix A

Ramin Aghevli, Reg. No. 43,462; William E. Alford, Reg. No. 37,764; Farzad E. Amini, Reg. No. 42,261; William Thomas Babbitt, Reg. No. 39,591; Jordan Michael Becker, Reg. No. 39,602; Michael A. Bernadicou, Reg. No. 35,934; Roger W. Blakely, Jr., Reg. No. 25,831; R. Alan Burnett, Reg. No. 46,149; Gregory D. Caldwell, Reg. No. 39,926; Jae-Hee Choi, Reg No. 45,288; Thomas M. Coester, Reg. No. 39,637; Robert P. Cogan, Reg. No. 25,049; Donna Jo Coningsby, Reg. No. 41,684; Florin Corie, Reg. No. 46,244; Mimi Diemmy Dao, Reg. No. 45,628; Dennis M. deGuzman, Reg. No. 41,702; Stephen M. De Klerk, Reg. No. 46,503; Michael Anthony DeSanctis, Reg. No. 39,957; Daniel M. De Vos, Reg. No. 37,813; Justin M. Dillon, Reg. No. 42,486; Sanjeet Dutta, Reg. No. 46,145; Matthew C. Fagan, Reg. No. 37,542; Tarek N. Fahmi, Reg. No. 41,402; Thomas S. Ferrill, Reg. No. 42,532; George Fountain, Reg. No. 37,374; Andre Gibbs, Reg. No. 47,593; James Y. Go, Reg. No. 40,621; Melissa A. Haapala, Reg No. 47,622; Alan Heimlich, Reg. No. 48,808; James A. Henry, Reg. No. 41,064; Libby H. Ho, Reg. No. 46,774; Willmore F. Holbrow III, Reg. No. 41,845; Sheryl Sue Holloway, Reg. No. 37,850; George W Hoover II, Reg. No. 32,992; Eric S. Hyman, Reg. No. 30,139; William W. Kidd, Reg. No. 31,772; Walter T. Kim, Reg. No. 42,731; Eric T. King, Reg. No. 44,188; Steve Laut, Reg. No. 47,736; George Brian Leavell, Reg. No. 45,436; Samuel S. Lee, Reg. No. 42791; Gordon R. Lindeen III, Reg. No. 33,192; Jan Carol Little, Reg. No. 41,181; Julio Loza, Reg. No. 47,758; Joseph Lutz, Reg. No. 43,765; Michael J. Mallie, Reg. No. 36,591; Andre L. Marais, Reg. No. 48,095; Paul A. Mendonsa, Reg. No. 42,879; Clive D. Menezes, Reg. No. 45,493; Richard A. Nakashima, Reg. No. 42,023; Stephen Neal Reg. No. 47,815; Chun M. Ng, Reg. No. 36,878; Thien T. Nguyen, Reg. No. 43,835; Thinh V. Nguyen, Reg. No. 42,034; Robert B. O'Rourke, Reg. No. 46,972; Daniel E. Ovanezian, Reg. No. 41,236; Gregg A. Peacock, Reg. No. 45,001; Marina Portnova, Reg. No. 45,750; Michael A. Proksch, Reg. No. 43,021; Randol W. Read, Reg. No. 43,876; William F. Ryann, Reg. 44,313; James H. Salter, Reg. No. 35,668; William W. Schaal, Reg. No. 39,018; James C. Scheller, Reg. No. 31,195; Jeffrey S. Schubert, Reg. No. 43,098; Saina Shamilov, Reg. No. 48,266; Maria McCormack Sobrino, Reg. No. 31,639; Stanley W. Sokoloff, Reg. No. 25,128; Judith A. Szepesi, Reg. No. 39,393; Ronald S. Tamura, Reg. No. 43,179; Edwin H. Taylor, Reg. No. 25,129; Lance A. Termes, Reg. No. 43,184; John F. Travis, Reg. No. 43,203; Kerry P. Tweet, Reg. No. 45,959; Mark C. Van Ness, Reg. No. 39,865; Tom Van Zandt, Reg. No. 43,219; Brent Vecchia, Reg No. 48,011; Lester J. Vincent, Reg. No. 31,460; Archana B. Vittal, Reg. No. 45,182; Glenn E. Von Tersch, Reg. No. 41,364; John Patrick Ward, Reg. No. 40,216; Mark L. Watson, Reg. No. 46,322; Thomas C. Webster, Reg. No. 46,154; and Norman Zafman, Reg. No. 26,250; my patent attorneys, and Charles P. Landrum, Reg. No. 46,855; Suk S. Lee, Reg. No. 47,745; and Raul Martinez, Reg. No. 46,904, Brent E. Vecchia, Reg. No. 48,011; Lehua Wang, Reg. No. P48,023; my patent agents, of BLAKELY, SOKOLOFF, TAYLOR & ZAFMAN LLP, with offices located at 12400 Wilshire Boulevard, 7th Floor, Los Angeles, Calif. 90025, telephone (310) 207-3800, and James R. Thein, Reg. No. 31,710, my patent attorney with full power of substitution and revocation, to prosecute this application and to transact all business in the Patent and Trademark Office connected herewith.

### Appendix B

### Title 37, Code of Federal Regulations, Section 1.56 Duty to Disclose Information Material to Patentability

(a) A patent by its very nature is affected with a public interest. The public interest is best served, and the most effective patent examination occurs when, at the time an application is being examined, the Office is aware of and evaluates the teachings of all information material to patentability. Each individual associated with the filing and prosecution of a patent application has a duty of candor and good faith in dealing with the Office, which includes a duty to disclose to the Office all information known to that individual to be material to patentability as defined in this section. The duty to disclose information exists with respect to each pending claim until the claim is cancelled or withdrawn from consideration, or the application becomes abandoned. Information material to the patentability of a claim that is cancelled or withdrawn from consideration need not be submitted if the information is not material to the patentability of any claim remaining under consideration in the application. There is no duty to submit information which is not material to the patentability of any existing claim. The duty to disclose all information known to be material to patentability is deemed to be satisfied if all information known to be material to patentability of any claim issued in a patent was cited by the Office or submitted to the Office in the manner prescribed by §§1.97(b)-(d) and 1.98. However, no patent will be granted on an application in connection with which fraud on the Office was practiced or attempted or the duty of disclosure was violated through bad faith or intentional misconduct. The Office encourages applicants to carefully examine:

(1) Prior art cited in search reports of a foreign patent office in a counterpart application, and

(2) The closest information over which individuals associated with the filing or prosecution of a patent application believe any pending claim patentably defines, to make sure that any material information contained therein is disclosed to the Office.

(b) Under this section, information is material to patentability when it is not cumulative to information already of record or being made of record in the application, and

(1) It establishes, by itself or in combination with other information, a prima facie case of unpatentability of a claim; or

(2) It refutes, or is inconsistent with, a position the applicant takes in:

(i) Opposing an argument of unpatentability relied on by the Office, or

(ii) Asserting an argument of patentability.

A prima facie case of unpatentability is established when the information compels a conclusion that a claim is unpatentable under the preponderance of evidence, burden-of-proof standard, giving each term in the claim its broadest reasonable construction consistent with the specification, and before any consideration is given to evidence which may be submitted in an attempt to establish a contrary conclusion of patentability.

(c) Individuals associated with the filing or prosecution of a patent application within the meaning of this section are:

(1) Each inventor named in the application;

(2) Each attorney or agent who prepares or prosecutes the application; and

(3) Every other person who is substantively involved in the preparation or prosecution of the application and who is associated with the inventor, with the assignee or with anyone to whom there is an obligation to assign the application.

(d) Individuals other than the attorney, agent or inventor may comply with this section by disclosing information to the attorney, agent, or inventor.

(e) In any continuation-in-part application, the duty under this section includes the duty to disclose to the Office all information known to the person to be material to patentability, as defined in paragraph (b) of this section, which became available between the filing date of the prior application and the national or PCT international filing date of the continuation-in-part application.

What is claimed is:

1. An apparatus to manage a plurality of device configurations comprising:
a control server to generate a job to update a device;
a control point to establish a secure communication with the control server, and to receive the job;
the control point to establish communication with the device in accordance with a maintenance schedule, and to update the device using the job.

2. The apparatus of claim 1, wherein the control server and the control point are co-resident on a single computer system.

3. The apparatus of claim 1, wherein the control point is further to communicate a result of the update process to the control server.

4. The apparatus of claim 3, wherein the communication of the result of the update process comprises a transcript of communication between the device and the control point.

5. The apparatus of claim 1, further comprising:
a data store coupled to the control server, the data store including a device profile identifying the device to be updated and the device's characteristics.

6. The apparatus of claim 5, wherein the control server comprises:
a data generator to generate device specific data from the device profile; and
a template interpreter to generate the job script based on the device specific data and template data.

7. The apparatus of claim 6, wherein a template group is attached to the device profile.

8. The apparatus of claim 6, wherein each device profile includes a device type, and a template group is attached to each device type.

9. The apparatus of claim 6, wherein the template interpreter further points to configuration files and supporting files.

10. The apparatus of claim 9, wherein the control point uses the job to interact with the device, and uploads the configuration files to the device.

11. The apparatus of claim 1, wherein the job is to audit the device.

12. The apparatus of claim 11, wherein the audit comprises retrieving configuration files from the device.

13. The apparatus of claim 11, wherein the audit comprises retrieving firmware from the device.

14. The apparatus of claim 11, wherein the audit comprises obtaining a checksum of the firmware of the device

15. The apparatus of claim 1, wherein the control server generates a job in response to receiving a change in the device profile.

16. The apparatus of claim 15, wherein the change in the device profile is made using a command line interface.

17. The apparatus of claim 1, wherein the control server further comprises a control point generator to permit creation of a new control point.

18. The apparatus of claim 17, wherein the control point generator comprises:
a localizer to generate a localized control point executable;
wherein the localization identifies a control server, such that the control point executable may only interface with the identified control server.

19. The apparatus of claim 18, wherein the identified control server is a control server group.

20. The apparatus of claim 19, wherein a single control server is designated as a default control server, and other members of the control server group enable fail-over if the default control server is unavailable.

21. The apparatus of claim 18, wherein the localized control point executable includes the control server's public key.

22. The apparatus of claim 17, wherein the control point generator comprises:
a pass phrase generator to generate a one-time pass phrase;
wherein upon installing a localized control point executable, the localized control point executable is activated using the pass phrase.

23. The apparatus of claim 22, wherein the pass phrase is a series of words from a dictionary.

24. The apparatus of claim 23, wherein pass phrase encodes a one-time password.

25. The apparatus of claim 17, wherein when the new control point is initialized using the localized control point executable, the new control point comprises:
a key generation logic to generate a public key and a private key for the control point;
a secure communication mechanism to communicate with the control server using a one-time password encoded in a pass phrase used to generate the new control point; and
the secure communication mechanism to complete a key exchange with the control server, such that public key cryptography is used for further secure communication.

26. The apparatus of claim 1, further comprising:
a scheduler in the control server to schedule an update of a particular device coupled to a control point, and when it is time to update the particular device, to send a communication request to the control point; and
a secure communication mechanism in the control point to respond to the request by establishing a secure communication link with the control server.

27. The apparatus of claim 26, wherein the secure communication link is secure shell (SSH).

28. The apparatus of claim 26, wherein the secure communication link is secure sockets layer (SSL).

29. The apparatus of claim 26, wherein the time to schedule an update of a particular device corresponds to a maintenance window of the device.

30. The apparatus of claim 26, wherein the device being updated is the control point.

31. The apparatus of claim 1, wherein the control point further comprises:
scheduler to schedule execution of each job received by the control point; and
a reporter to report back results of the execution of each job to the control server.

32. The apparatus of claim 31, wherein the results comprise a complete transcript of communication with the device to which the job was directed.

33. The apparatus of claim 1, further comprising a data store including a device profile defining a current state of the device.

34. The apparatus of claim 33, wherein the data store is a SQL database, and the data store is displayed as a hierarchical data store.

35. The apparatus of claim 33, wherein the data store comprises a plurality of data types and new data types may be arbitrarily defined.

36. The apparatus of claim 33, wherein the data store further comprises the past states of the device.

37. The apparatus of claim 34, further comprising a service module coupled to the control server, the service module to define a functionality that may be provided through the control server, the service module having a separate user interface.

38. The apparatus of claim 37, wherein a service module comprises:
a user interface;
a command line interface to receive user input and convert it into commands; and
a service module core to define a functionality to alter data in the data store, such that the change flows down to the control points and the devices.

39. The apparatus of claim 38, wherein the service module core is further to define arbitrary attributes for data in the data store.

40. A control server to manage a plurality of device configurations comprising:
a data store to store current status of each device;
a user interface to alter data in the data store to prompt creation of a job;
a scheduler to schedule jobs to update devices;
a control point interface to send jobs to a control point, and to receive a result from the control point.

41. The control server of claim 40, wherein the user interface is a command line interface (CLI) permitting the creation of action scripts to make complex alterations to the devices, the control points, and the data store.

42. The control server of claim 40, wherein the data store is an SQL database presented in a hierarchical fashion.

43. The control server of claim 40, further comprising a device module to generate a job for a particular device.

44. The control server of claim 43, wherein the device module comprises:
a controller to create data from a device profile; and
a master to create a job using the data produced by the controller.

45. The control server of claim 44, wherein the master further to determine whether to create a job.

46. The control server of claim 44, wherein the device module further comprises:
a template to create device configuration files; and
a job to deliver changes to the device.

47. The control server of claim 44, wherein the device profile comprises a descriptive triplet including a device module name, device platform, and firmware revision, the device profile specifying how a particular device is configured.

48. A control point to serve as an interface to a plurality of devices, the control point managed by a control server, the control point comprising:
a scheduling logic to schedule a job in accordance with a maintenance window defined by the job;
an execution environment for a delivery driver to deliver a job to a device in accordance with the maintenance window of the device, as specified by the job.

49. The control point of claim 48, further comprising:
the scheduling logic to schedule interfacing the control point with the control server to receive jobs and updates.

50. The control point of claim 48, further comprising:
a secure communications channel to securely communicate with a control server.

51. The control point of claim 48, wherein the control point is a stand-alone system, running a secure/hardened operating system.

52. The control point of claim 48, wherein the control point operates as an application on a non-dedicated computer system.

53. The control point of claim 52, wherein the control point on the non-dedicated computer system further comprises:
a system state monitor to control the network and network applications settings on the standard computer system.

54. The control point of claim 48 further comprising:
a cache to store files used by a job, such that the files may be reused and the jobs sent need not include the files.

55. The control point of claim 54, a wherein a job includes references to a plurality of files, and if the files are not in the cache, the secure communications channel further to request the files from the control server.

56. The control point of claim 48, further comprising:
an execution environment for delivery drivers to execute the indicated processes and jobs.

57. The control point of claim 48, wherein the control point has a maintenance window, such that the control point is updateable by the control server.

58. A method of controlling a network comprising:
determining if there is a job for a control point;
establishing a secure connection between a control server and the control point;
sending the job to the control point, including a maintenance window during which the job is to be performed; and
receiving job statuses of previous jobs from the control point; and
closing the connection with the control point.

59. The method of claim 58, wherein the job is to update the control point, and the maintenance window is the maintenance window of the control point.

60. The method of claim 58, wherein the job is to update a device coupled to the control point.

61. The method of claim 58, wherein if the job is to update a device coupled to the control point, the maintenance window is the maintenance window of the device to which the job applies.

62. A method of controlling a network comprising:
establishing a secure session between a control server and a control point;
receiving a job from the control server, including a maintenance window during which the job is to be performed;
putting the job into a job queue;
sending job statuses of previous jobs to the control server; and
closing the connection with the control server.

63. The method of claim 62, further comprising:
determining that there is a job in the job queue that has a current maintenance window;
connecting to the device using credentials;
executing the job in the control point to affect the device;
storing the results of the job as the job status; and
disconnecting from the device.

64. The method of claim 63, wherein the credentials are a password.

65. The method of claim 63, wherein running the job comprises:
determining if the device is in an expected state; and
updating and configuring the device as specified by a job script within the job.

66. The method of claim 63, wherein if the device is not in the expected state, the device is not updated, and the non-compliant state data is returned to the control server.

67. The method of claim 66, further comprising:
raising an alarm when the non-compliant state data is returned.

68. A method of controlling a network including a control point controlled by a control server, the control point controlling the devices on the network in accordance with jobs sent by the control server, the method including creating new control points, the method of creating a control point comprising:
generating a branded executable for the control point including the control server's public key;
generating a passphrase including a one-time password for activating the control point; and
upon installation of the branded executable and activation with the passphrase, receiving a connection from the new control point using the one-time password from the passphrase.

69. The method of claim 68, further comprising:
verifying that the control point identified by the one-time password is valid and not yet activated; and
establishing a secure communications channel with the control point.

70. The method of claim 68, wherein the passphrase is a plurality of words in the English language.

71. The method of claim 68, wherein the passphrase is three or more words having four or more letters, such that the passphrase is easily transmitted via voice communication.

72. The method of claim 68, further comprising:
creating a public/private keypair for the new control point, and using that public/private keypair for establishing secure communication with the control point.

73. A method of controlling a network using a control server, the method comprising:
maintaining a data store including configurations of each device coupled to the control server through a control point;
generating a job to update a device;
receiving a report from the control point regarding the execution of the job to update the device; and
storing in the data store the report with the current configuration of the device, such that a complete revision history of the device is maintained.

74. The method of claim 73, wherein the revision history of the device includes a previous device profile for that device, enabling a new device to be configured identically to the original device, even if the new device is of a different make.

75. The method of claim 73, wherein the revision history of the device includes a previous device configuration file, enabling a review of the state of the device at any point in the past.

76. The method of claim 73, wherein the revision history includes time and date stamps for each alteration to a device.

77. The method of claim 73, wherein the job is generated in response to a change in the data store.

78. A method of controlling a network including a control point controlled by a control server, the control point interacting with the devices on the network in accordance with jobs sent by the control server, the method comprising generating a job comprising:
identifying a device profile of the device for which the job is to be generated;
using a controller in the device profile to preprocess data needed for the job; and
using a master in the device profile to generate the job based on the preprocessed data, thereby creating a job for the device.

79. The method of claim 78, further comprising:
the master determining that no job needs to be generated.

80. The method of claim 78, wherein the job is generated in response to a change in a data store.

81. The method of claim 78, wherein the job includes a maintenance window of the device, the maintenance window defining a time period during which the job is to be executed.

82. The method of claim 78, wherein the job includes a JobScript to execute the job.

83. The method of claim 78, wherein the job references other data in a data store, used by the job.

84. The method of claim 83, wherein if the other data is already in a cache in the control point, it is not sent to the control point.

85. A method of remotely manipulating a device coupled to a control point, the control point managed by a control server, comprising:
generating a job to manipulate the device;
sending the job to the control point to which the device is coupled; and
providing an execution engine to execute the job on the control point.

86. The method of claim 85, wherein manipulating the device comprises one or more of the following: initializing the device, updating the device, configuring the device, and auditing the device.
